(19) United States
(12) Patent Application Publication
(10) Pub. No.: US 2019/0124022 A1
(43) Pub. Date: Apr. 25, 2019

(54) SYSTEM AND METHOD FOR REDUCED VISUAL FOOTPRINT OF TEXTUAL COMMUNICATIONS

(71) Applicant: NORTH INC., Kitchener (CA)

(72) Inventors: Brent Bisaillion, Kitchener (CA); William S.L. Walmsley, Toronto (CA); W. Xavier Snelgrove, Toronto (CA); Severin O.A. Smith, Toronto (CA)

(21) Appl. No.: 16/171,238

(22) Filed: Oct. 25, 2018

Related U.S. Application Data
(60) Provisional application No. 62/577,081, filed on Oct. 25, 2017.

(51) Int. Cl. H04L 12/58; G06F 3/0482; G06F 17/27

(52) U.S. Cl. CPC H04L 51/10; G06F 3/0482; G02B 27/0172; H04L 51/046; G06F 17/27

(57) ABSTRACT

Systems and methods are disclosed for providing communication between processor-based devices. The system includes at least one processor-readable medium communicatively coupled to at least one processor and which stores processor-executable instructions that, when executed by the at least one processor, cause the at least one processor to: identify a first textual message generated at a first processor-based device that is designated for visual presentation via a second processor-based device, the first textual message including a plurality of alphanumeric characters; perform a classification on the first textual message that converts the first textual message into one or more graphic or pictorial symbols; and cause a presentation of the one or more graphic or pictorial symbols in lieu of, and without presentation of, the first textual message using the second processor-based device.

### BACKGROUND

### Technical Field

The present disclosure generally relates to textual communication systems and methods, and particularly, to systems and methods for reducing the visual footprint of textual communications on a display device.

### Description of the Related Art

Electronic devices are commonplace throughout most of the world today. Advancements in integrated circuit technology have enabled the development of electronic devices that are sufficiently small and lightweight to be carried by the user. Such “portable” electronic devices may include on-board power supplies (such as batteries or other power storage systems) and may be designed to operate without any wire-connections to other, non-portable electronic systems; however, a small and lightweight electronic device may still be considered portable even if it includes a wire-connection to a non-portable electronic system. For example, earphones may be considered a portable electronic device whether they are operated wirelessly or through a wire-connection.

The convenience afforded by the portability of electronic devices has fostered a huge industry. Smartphones, audio players, laptop computers, tablet computers, and ebook readers are all examples of portable electronic devices. However, the convenience of being able to carry a portable electronic device has also introduced the inconvenience of having the screen size of these portable electronic devices become smaller. For example, wearable electronic devices tend to have even smaller screens than handheld devices.

A wearable electronic device is any portable electronic device that a user can carry without physically grasping, clutching, or otherwise holding onto the device with their hands. For example, a wearable electronic device may be attached or coupled to the user by a strap or straps, a band or bands, a clip or clips, an adhesive, a pin and clasp, an article of clothing, tension or elastic support, an interference fit, an ergonomic form, and the like. Examples of wearable electronic devices include digital wristwatches, electronic armbands, electronic rings, electronic ankle-bracelets or “anklets,” head-mounted electronic display units, hearing aids, and so on.

Some types of wearable electronic devices that have the electronic displays described above may include wearable heads-up displays. A wearable heads-up display is a head-mounted display that enables the user to see displayed content but does not prevent the user from being able to see their external environment. A typical head-mounted display (e.g., well-suited for virtual reality applications) may be opaque and prevent the user from seeing their external environment, whereas a wearable heads-up display (e.g., well-suited for augmented reality applications) may enable a user to see both real and virtual/projected content at the same time. A wearable heads-up display is an electronic device that is worn on a user's head and, when so worn, secures at least one display within a viewable field of at least one of the user's eyes at all times, regardless of the position or orientation of the user's head, but this at least one display is either transparent or at a periphery of the user's field of view so that the user is still able to see their external environment. Examples of wearable heads-up displays include: Google Glass®, Optinvent Ora®, Epson Moverio®, and Sony Glasstron®.

One problem with wearable electronic devices and portable electronic devices today is that since users are almost always carrying or wearing one or more of these devices, the user become inundated with information, notifications, messages, and the like. This level of intrusion can result in a very unpleasant experience for users of wearable electronic devices and portable electronic devices today due to these constant distractions and the amount of information that must be processed in these distractions.

Additionally, wearable electronic devices, including wearable heads-up displays tend to have smaller screens than handheld devices or portable laptop type devices. Accordingly, there is a continuing need in the art to communicate visually using portable electronic devices with smaller screens by finding new techniques for utilizing small display screens efficiently.

### BRIEF SUMMARY

A method of operation in a processor-based system, the processor-based system comprising at least one processor and at least one processor-readable medium communicatively coupled to the at least one processor and which stores at least one of processor-executable instructions may be summarized as including: for a first textual message being sent from a first processor-based device to a second processor-based device for visual presentation via the second processor-based device, the first textual message comprising a plurality of alphanumeric characters, performing a classification on the first textual message that results in one or more graphic or pictorial symbols; and causing a presentation of the one or more graphic or pictorial symbols in lieu of, and without presentation of, the first textual message using the second processor-based device.

Performing a classification on the first textual message that results in one or more graphic or pictorial symbols may include performing a classification on the first textual message that results in one or more graphic or pictorial symbols that collectively occupy a smaller area than an area that would be occupied by the first textual message if presented in full at a same font and size as a presentation of the one or more graphic or pictorial symbols. Performing a classification on the first textual message that results in one or more graphic or pictorial symbols may include performing a classification on the first textual message that results in one or more graphic or pictorial symbols that include no alphanumeric characters. Performing a classification on the first textual message that results in one or more graphic or pictorial symbols may include performing a classification on the first textual message that results in one or more graphic or pictorial symbols that include at least one emoji character. Performing a classification on the first textual message that results in one or more graphic or pictorial symbols may include performing a classification using a machine-learning-based classifier.

The method of operation in a processor-based system, the processor-based system comprising at least one processor and at least one processor-readable medium communicatively coupled to the at least one processor and which stores at least one of processor-executable instructions may further include training a classifier with the first textual message.

Causing a presentation of the one or more graphic or pictorial symbols in lieu of, and without presentation of, the first textual message by the second processor-based device may include transmitting information to the second processor-based device. Causing a presentation of the one or more graphic or pictorial symbols in lieu of, and without presentation of, the first textual message by the second processor-based device may include transmitting information that, at least initially, causes a presentation of the one or more graphic or pictorial symbols via at least the second processor-based device, the at least initial presentation of the one or more graphic or pictorial symbols in lieu of, and without, the first textual message.

The method of operation in a processor-based system, the processor-based system comprising at least one processor and at least one processor-readable medium communicatively coupled to the at least one processor and which stores at least one of processor-executable instructions may further include receiving the first textual message at an intermediary processor-based system directly or indirectly from the first processor-based device, and wherein the performing a classification on the first textual message that results in one or more graphic or pictorial symbols may be performed by the intermediary processor-based system.

Causing a presentation of the one or more graphic or pictorial symbols in lieu of, and without presentation of, the first textual message by the second processor-based device may include transmitting the information by the intermediary processor-based system directly or indirectly to the at least second processor-based device. The second processor-based device may be a wearable heads-up display causing a presentation of the one or more graphic or pictorial symbols in lieu of, and without presentation of, the first textual message by the second processor-based device including causing a presentation of the one or more graphic or pictorial symbols by the wearable heads-up display.

The method of operation in a processor-based system, the processor-based system comprising at least one processor and at least one processor-readable medium communicatively coupled to the at least one processor and which stores at least one of processor-executable instructions may further include receiving user input that specifies the first textual message at the first processor-based device, and wherein the performing a classification on the first textual message that results in one or more graphic or pictorial symbols may be performed by the first processor-based device.

Causing a presentation of the one or more graphic or pictorial symbols in lieu of, and without presentation of, the first textual message by the second processor-based device may include transmitting information that at least one of includes or specifies the one or more graphic or pictorial symbols and that also at least one of includes or specifies a first set of corresponding textual information that is presentable subsequently to the presentation of the one or more graphic or pictorial symbols, and which does not include the first textual message. Transmitting information that, at least initially, causes a presentation of the one or more graphic or pictorial symbols via the at least second device in lieu of, and without, the first textual message may include transmitting the information that at least one of includes or specifies the one or more graphic or pictorial symbols and that also at least one of includes or specifies the first textual message that is presentable subsequently to the presentation of the one or more graphic or pictorial symbols. Transmitting information that, at least initially, causes a presentation of the one or more graphic or pictorial symbols via the at least second device in lieu of, and without, the first textual message may include transmitting the information that at least one of includes or specifies the one or more graphic or pictorial symbols and also at least one of includes or specifies a first set of corresponding textual information that does not include the first textual message, and further also may include the first textual message, the first textual message presentable subsequently to the presentation of the one or more graphic or pictorial symbols.

The method of operation in a processor-based system, the processor-based system comprising at least one processor and at least one processor-readable medium communicatively coupled to the at least one processor and which stores at least one of processor-executable instructions may further include: for the first textual message being sent from the first processor-based device to the second processor-based device for visual presentation via the second processor-based device, performing a classification on the first textual message that results in one or more possible responses to the first textual message; and causing a presentation of the one or more possible responses, the presentation via the at least second processor-based device.

Performing a classification on the first textual message that results in one or more possible responses to the first textual message may include performing a classification on the first textual message that results in one or more responses represented in textual form. Performing a classification on the first textual message that results in one or more possible responses to the first textual message may include performing a classification on the first textual message that results in one or more responses represented in graphical or pictorial form.

The method of operation in a processor-based system, the processor-based system comprising at least one processor and at least one processor-readable medium communicatively coupled to the at least one processor and which stores at least one of processor-executable instructions may further include receiving the first textual message at an intermediary processor-based system directly or indirectly from the first processor-based device, and wherein the performing a classification on the first textual message that results in one or more possible responses may be performed by the intermediary processor-based system.

Causing a presentation of the one or more possible responses, the presentation via the at least second processor-based device may include causing a presentation of the one or more possible responses as one or more graphical or pictorial symbols in lieu of, and without presentation of, textual representations of the one or more possible responses, the presentation via the second processor-based device.

The method of operation in a processor-based system, the processor-based system comprising at least one processor and at least one processor-readable medium communicatively coupled to the at least one processor and which stores at least one of processor-executable instructions may further include, in response to detection of an input at the second processor-based device, causing a presentation of the one or more possible responses as one or more textual representations of the one or more possible responses, the presentation via the second processor-based device.

Causing a presentation of the one or more possible responses as one or more textual representations of the one or more possible responses may include replacing the one or more graphical or pictorial symbol representations of the possible responses with the one or more textual representations of the one or more possible responses. The detected input at the second processor-based device may be selection of one of the one or more graphical or pictorial symbol representations of the possible responses.

The method of operation in a processor-based system, the processor-based system comprising at least one processor and at least one processor-readable medium communicatively coupled to the at least one processor and which stores at least one of processor-executable instructions may further include: identifying a selected one of the possible responses; and training a classifier using selected one of the possible responses.

A system including at least one processor and at least one processor-readable medium communicatively coupled to the at least one processor and which stores at least one of processor-executable instructions may be summarized as including: a first processor-based device; a second processor-based device, wherein a first textual message is sent from the first processor-based device to the second processor-based device for visual presentation via the second processor-based device, the first textual message comprising a plurality of alphanumeric characters, the system performing a classification on the first textual message that converts the first textual message into one or more graphic or pictorial symbols; and the system causing a presentation of the one or more graphic or pictorial symbols in lieu of, and without presentation of, the first textual message using the second processor-based device.

The one or more graphic or pictorial symbols may collectively occupy a smaller area than an area that would be occupied by the first textual message if presented in full at a same font and size as a presentation of the one or more graphic or pictorial symbols. The one or more graphic or pictorial symbols may include no alphanumeric characters. The one or more graphic or pictorial symbols may include at least one emoji character. The system may perform the classification on the first textual message that converts the first textual message into one or more graphic or pictorial symbols using a machine-learning-based classifier. The system may train the classifier with the first textual message to generate more accurate graphic or pictorial symbols. The system may transmit information to the second processor-based device that causes the presentation of the one or more graphic or pictorial symbols in lieu of, and without presentation of, the first textual message by the second processor-based device. The system may transmit information that, at least initially, causes the presentation of the one or more graphic or pictorial symbols via at least the second processor-based device, the at least initial presentation of the one or more graphic or pictorial symbols in lieu of, and without, the first textual message. The system may receive the first textual message at an intermediary processor-based system directly or indirectly from the first processor-based device, wherein the intermediary processor-based system performs the classification on the first textual message that converts the first textual message into one or more graphic or pictorial symbols. The system may transmit information by the intermediary processor-based system directly or indirectly to the at least second processor-based device. The second processor-based device may be a wearable heads-up display, the system causing the presentation of the one or more graphic or pictorial symbols using the wearable heads-up display. The system may receive user input that specifies the first textual message at the first processor-based device, and wherein the system may perform the classification on the first textual message that converts the first textual message into one or more graphic or pictorial symbols using the first processor-based device. The system may cause the presentation of the one or more graphic or pictorial symbols by transmitting information that includes (1) the one or more graphic or pictorial symbols, and (2) a first set of corresponding textual information that is presentable subsequently to the presentation of the one or more graphic or pictorial symbols, the first set of corresponding textual information not including the first textual message. The system may transmit information that includes (1) the one or more graphic or pictorial symbols, and (2) the first textual message, which is presentable subsequently to the presentation of the one or more graphic or pictorial symbols. The system may transmit information that includes (1) the one or more graphic or pictorial symbols, (2) a first set of corresponding textual information, the first set of corresponding textual information not including the first textual message, and (3) the first textual message, presentable subsequently to the presentation of the one or more graphic or pictorial symbols. The system may perform a classification on the first textual message that results in one or more possible responses to the first textual message, and wherein the system may cause a presentation of the one or more possible responses via the at least second processor-based device. The one or more possible responses may be represented in textual form. The one or more responses may be represented in graphical or pictorial form. The system may receive the first textual message at an intermediary processor-based system directly or indirectly from the first processor-based device, and wherein the intermediary processor-based system may perform the classification on the first textual message that results in one or more possible responses. The one or more possible responses may be presented, via the second processor-based device, as one or more graphical or pictorial symbols in lieu of, and without presentation of, textual representations of the one or more possible responses. The one or more possible responses may be presented, via the second processor-based device, as one or more graphical or pictorial symbols in response to detection of an input at the second processor-based device. The one or more possible responses may be presented, via the second processor-based device, as one or more textual representations of the one or more possible responses. The detected input at the second processor-based device may include a user selection of one of the one or more graphical or pictorial symbol representations of the possible responses. The system may train a classifier using a selection of one of the possible responses as data for use in training the classifier.

A system for providing communication between processor-based devices may be summarized as including: at least one processor-readable medium communicatively coupled to at least one processor and which stores processor-executable instructions that, when executed by the at least one processor, cause the at least one processor to: identify a first textual message generated at a first processor-based device that is designated for visual presentation via a second processor-based device, the first textual message includes a plurality of alphanumeric characters, perform a classification on the first textual message that converts the first textual message into one or more graphic or pictorial symbols; and cause a presentation of the one or more graphic or pictorial symbols in lieu of, and without presentation of, the first textual message using the second processor-based device.

The one or more graphic or pictorial symbols may collectively occupy a smaller area than an area that would be occupied by the first textual message if presented in full at a same font and size as a presentation of the one or more graphic or pictorial symbols. The one or more graphic or pictorial symbols may include no alphanumeric characters. The one or more graphic or pictorial symbols may include at least one emoji character. The system may perform the classification on the first textual message that converts the first textual message into one or more graphic or pictorial symbols using a machine-learning-based classifier. The system may train the classifier with the first textual message to generate more accurate graphic or pictorial symbols. The system may transmit information to the second processor-based device that causes the presentation of the one or more graphic or pictorial symbols in lieu of, and without presentation of, the first textual message by the second processor-based device. The system may transmit information that, at least initially, causes the presentation of the one or more graphic or pictorial symbols via at least the second processor-based device, the at least initial presentation of the one or more graphic or pictorial symbols in lieu of, and without, the first textual message. The system may receive the first textual message at an intermediary processor-based system directly or indirectly from the first processor-based device, wherein the intermediary processor-based system may perform the classification on the first textual message that converts the first textual message into one or more graphic or pictorial symbols. The system may transmit information by the intermediary processor-based system directly or indirectly to the at least second processor-based device. The second processor-based device may be a wearable heads-up display, the system causing the presentation of the one or more graphic or pictorial symbols using the wearable heads-up display. The system may receive user input that specifies the first textual message at the first processor-based device, and wherein the system may perform the classification on the first textual message that results in one or more graphic or pictorial symbols using the first processor-based device. The system may cause the presentation of the one or more graphic or pictorial symbols by transmitting information that includes (1) the one or more graphic or pictorial symbols, and (2) a first set of corresponding textual information that is presentable subsequently to the presentation of the one or more graphic or pictorial symbols, the first set of corresponding textual information not including the first textual message. The system may transmit information that includes (1) the one or more graphic or pictorial symbols, and (2) the first textual message, which is presentable subsequently to the presentation of the one or more graphic or pictorial symbols. The system may transmit information that includes (1) the one or more graphic or pictorial symbols, (2) a first set of corresponding textual information, the first set of corresponding textual information not including the first textual message, and (3) the first textual message, presentable subsequently to the presentation of the one or more graphic or pictorial symbols. The system may perform a classification on the first textual message that results in one or more possible responses to the first textual message, and wherein the system may cause a presentation of the one or more possible responses via the at least second processor-based device. The one or more possible responses may be represented in textual form. The one or more responses may be represented in graphical or pictorial form. The system may receive the first textual message at an intermediary processor-based system directly or indirectly from the first processor-based device, and wherein the intermediary processor-based system may perform the classification on the first textual message that results in one or more possible responses. The one or more possible responses may be presented, via the second processor-based device, as one or more graphical or pictorial symbols in lieu of, and without presentation of, textual representations of the one or more possible responses. The one or more possible responses may be presented, via the second processor-based device, as one or more graphical or pictorial symbols in response to detection of an input at the second processor-based device. The one or more possible responses may be presented, via the second processor-based device, as one or more textual representations of the one or more possible responses. The detected input at the second processor-based device may include a user selection of one of the one or more graphical or pictorial symbol representations of the possible responses. The system may train a classifier using a selection of one of the possible responses as data for use in training the classifier.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements are arbitrarily enlarged and positioned to improve drawing legibility. Further, the particular shapes of the elements as drawn are not necessarily intended to convey any information regarding the actual shape of the particular elements, and have been solely selected for ease of recognition in the drawings.

FIG. 1 is a schematic diagram showing a smart glasses interface with a traditional textual message delivered on the display screen.

FIG. 2 is a schematic diagram showing a smart glasses interface with a single graphic symbol on the display screen with a reduced visual footprint.

FIG. 3 is a flow-diagram showing an exemplary method of controlling smart glasses in accordance with the present systems and methods.

FIG. 4 is a logic flow-diagram showing an exemplary method of reducing a traditional textual message from an electronic device of a first user to a single graphic symbol on the display screen of a second user's electronic device.

FIG. 5 is a logic flow-diagram showing an exemplary method of a second user responding to receipt of the single graphic symbol on the display screen of the second user's electronic device, from the electronic device of the first user.

FIG. 6 is a block diagram of an example processor-based device used to implement one or more of the electronic device described herein, according to one non-limiting illustrated implementation.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures associated with electronic devices, and in particular portable electronic devices such as wearable electronic devices, have not been shown or described in detail to avoid unnecessarily obscuring descriptions of the implementations.

Unless the context requires otherwise, throughout the specification and claims which follow, the word “comprise” and variations thereof, such as, “comprises” and “comprising” are to be construed in an open, inclusive sense, that is, as “including, but not limited to.”

Reference throughout this specification to “one implementation” or “an implementation” means that a particular feature, structures, or characteristics may be combined in any suitable manner in one or more implementations.

As used in this specification and the appended claims, the singular forms “a,” “an,” and “the” include plural referents unless the content clearly dictates otherwise. It should also be noted that the term “or” is generally employed in its broadest sense, that is, as meaning “and/or” unless the content clearly dictates otherwise. The headings and Abstract of the Disclosure provided herein are for convenience only and do not interpret the scope or meaning of the implementations.

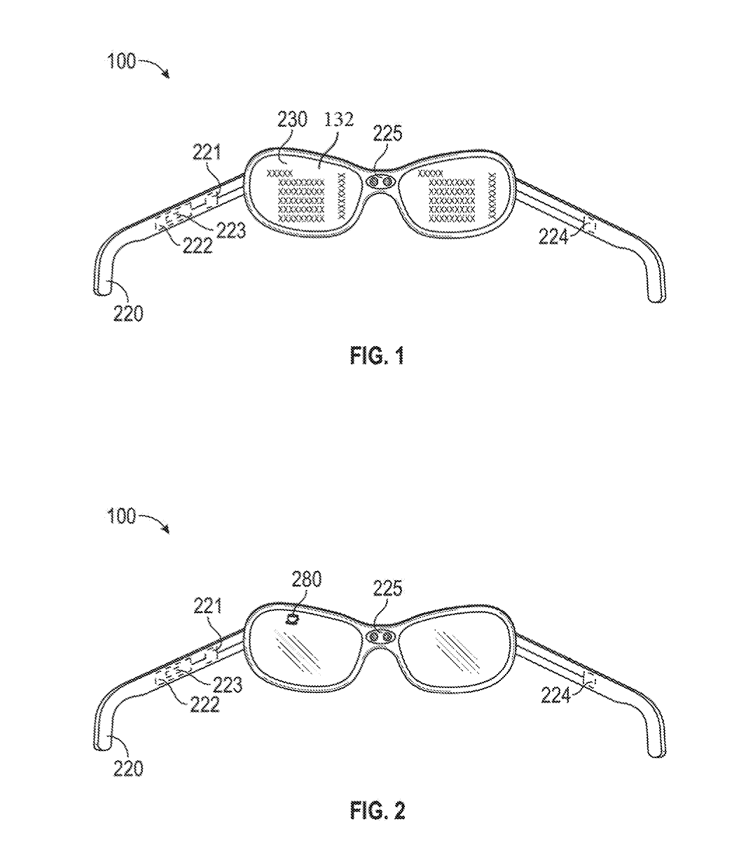

FIGS. 1-3 present illustrative diagrams of a system for reduced visual footprint of textual communications 100. The system for reduced visual footprint of textual communications 100 generates a visual summary of a textual communication and presents this visual summary to a pair of smart glasses (or other electronic communication device of limited display screen size) of a user, as a quick glimpse of the textual communication rather than showing the full textual communication itself, at least in the initial presentation.

The system for reduced visual footprint of textual communications 100 is suitable for the display of any electronic device with communication functionality. However, the system for reduced visual footprint of textual communications 100 is particularly well-suited for wearable heads-up displays, smart glasses, see-through displays, smart watches, fitness trackers, and other electronic devices that have small screen sizes. Since these devices have smaller screen sizes than, for example, a desktop computer, there is increased efficiency achieved by reducing a textual communication to the largest extent possible while maintaining the communication of the substance or essence of the textual communication.

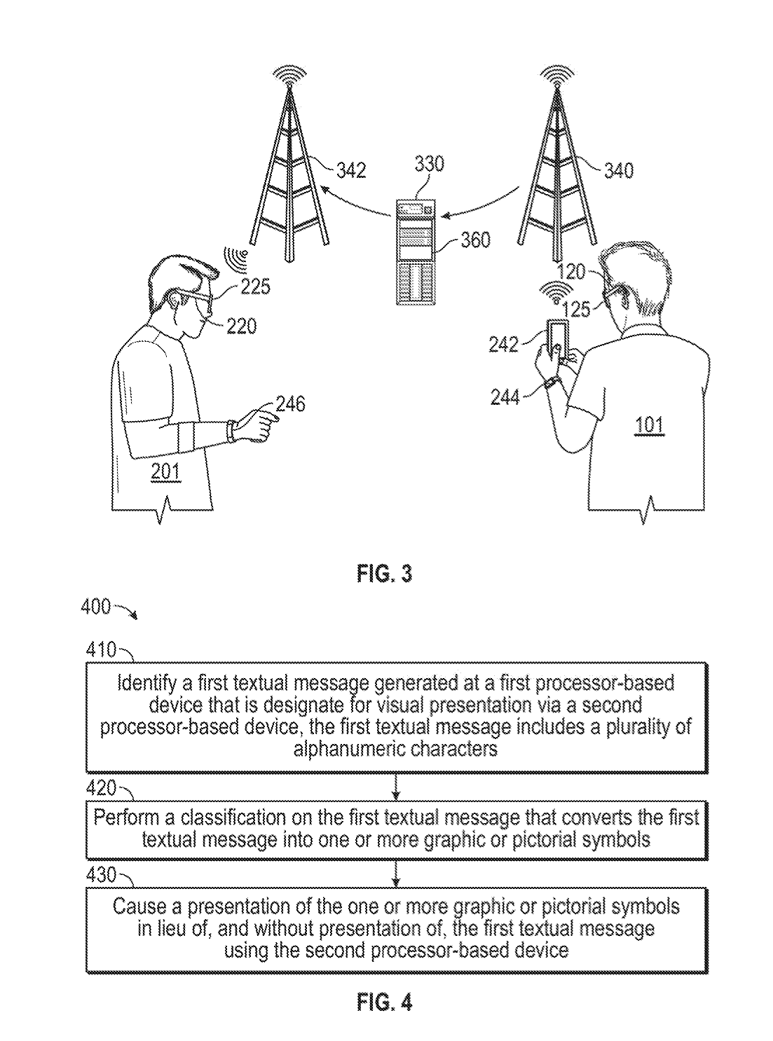

The system includes at least one processor and a non-transitory processor-readable medium communicatively coupled to the at least one processor. The processor-readable medium stores processor-executable instructions. Referring to FIG. 3, the system includes at least a first processor-based device 120 of a first user 101 and at least a second processor-based device 220 of a second user 201. The second processor-based device 220 of the second user 201 includes at least one display screen 230 configured to display textual communications from the first processor-based device 120 of the first user 101 in accordance with the present systems and methods. In this manner, an original textual message 132 is sent from the first processor-based device 120 of the first user 101 to the second processor-based device 220 of the second user 201 for visual presentation of the original textual message 132 on the display screen(s) 230 of the second processor-based device 220 (as shown in FIG. 1). The original textual message 132 includes a plurality of alphanumeric characters that together forms words, phrases, sentences, and/or combinations thereof.

As shown in FIGS. 1-3, in one implementation, the at least a first processor-based device 120 and the at least a second processor-based device 220 may include respective wearable smart glasses. In other implementations, either or both of the at least a first processor-based device and/or the at least a second processor-based device may include a smart phone 242, phablet (not shown), tablet computer (not shown), laptop computer (not shown), smart watch 244, fitness tracker device 246, and/or the like. In some implementations, the at least a first processor-based device 120 may include a pair of wearable smart glasses and a smartphone in communication with one another (e.g., each having a respective processor communicatively coupled to a respective wireless transceiver, and the respective wireless transceivers wirelessly in communication with one another). Generally, the system for reduced visual footprint of textual communications 100 may be implemented using any type of communication device and/or internet connected device, as part of any combination of multiple types of communication devices and/or internet connected devices, in which display screen size is at a premium, typically due to the smaller screen sizes of these devices.

As shown in FIGS. 1 and 2, in the system for reduced visual footprint of textual communications 100, the second processor-based device 220 includes a second interface device 225, which comprises an eye-tracker positioned in the center of the wearable heads-up display 220. The second interface device 225 is responsive to eye positions and/or eye movements of the user 201 when the wearable heads-up display 220 is worn by the second user. Eye-tracker 225 may track one or both eyes of the user and may, for example, employ images/video from cameras, reflection of projected/scanned infrared light, detection of iris or pupil position, detection of glint origin, and so on. Correspondingly, the first processor-based device 120 includes a first interface device 125, which comprises an eye-tracker positioned in the center of the wearable heads-up display 120, as shown in FIG. 3. The first processor-based device 120 and its components function in the same manner as the second processor-based device 220 and its components.

As shown in FIG. 1, the wearable heads-up display 220 of the second user 201 provides an original textual message 132 on the display screen(s) 230 to the second user 201. The second user 201 may interact with the original textual message 132 by performing physical gestures or interactions with an additional control mechanism or device (not shown) that are detected by second processor-based device 220. Exemplary additional control mechanisms and devices are described in, for example, US Patent Application Publication No. 2014-0198035 and US Patent Application Publication No. 2017-0097753. In accordance with the present systems and methods, second interface device 225 sends input data (e.g., based on the user's eye position and/or gaze direction) to the second processor-based device 220. The second processor-based device 220 may then send corresponding data to the first processor-based device 120 of the first user 101, typically by way of at least one intermediary processor-based device, such as a server 330 (shown in FIG. 3) and, optionally, one or more intervening smartphone device(s) (not shown in FIG. 3 to reduce clutter).

The system for reduced visual footprint of textual communications 100 performs a classification on the original textual message 132 that converts the original textual message 132 into one or more graphic or pictorial symbols 280 (see FIG. 2). In one implementation, the system causes the presentation of the graphic or pictorial symbols 280 on the display screen 230 of the second processor-based device 220 of the second user 201, without the presentation of the original textual message 132 on the display screen 230 of the second processor-based device 220 of the second user 201. Specifically, in one implementation, the wearable heads-up display 220 of the second user 201 provides the converted graphic or pictorial symbols 280 on the display screens 230 to the second user 201 and, optionally, does not initially provide the original textual message 132 on the display screens 230 to the second user 201. As described above, the second user 201 may interact with graphic or pictorial symbols 280 by performing physical gestures or activating one or more input mechanism(s) (e.g., button(s), joystick(s), touch sensor(s), or similar) that are detected by second processor-based device 220 or by a separate input device in communication with second processor-based device 220. In accordance with the present systems and methods, second interface device 225 sends input data (e.g., based on the user's eye position and/or gaze direction) to the second processor-based device 220. The second processor-based device 220 may then send corresponding data to the first processor-based device 120 of the first user 101, typically by way of an intermediary processor-based device, such as a server 330 (shown in FIG. 3) and, optionally, one or more intervening smartphone device(s) (not shown in FIG. 3 to reduce clutter).

A person of skill in the art will appreciate, however, that while the second processor-based device 220 is a wearable heads-up display that optionally includes an eye-tracker 225 in one implementation, in other exemplary implementations of the present systems and method, the second processor-based device 220 may comprise other electronic devices, such as smart phones 242, phablets (not shown), tablet computers (not shown), laptop computers (not shown), smart watches 244, fitness tracker devices 246, and the like. In practice, the teachings described herein may generally be applied using any combination of a first processor-based device 120 that is responsive to inputs from a first user 101 and a second processor-based device 220 that is responsive to inputs from a second user 201.

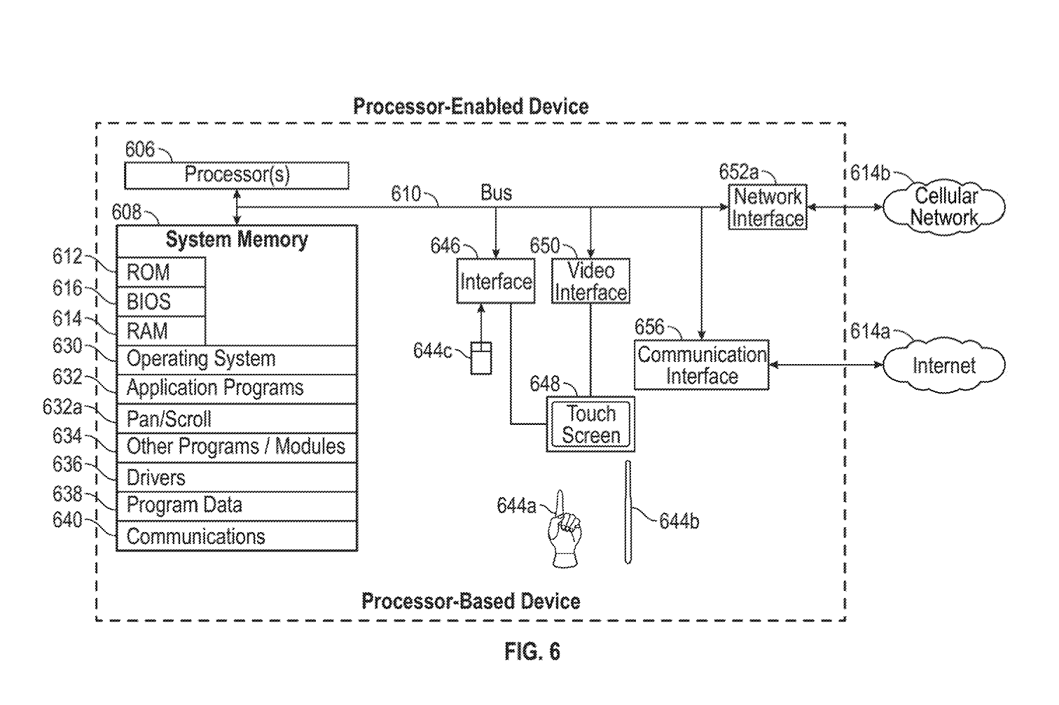

In the implementation shown in FIGS. 1 and 2, the second processor-based device 220 (e.g., a wearable heads-up display) also includes a processor 221 and a non-transitory processor-readable storage medium or memory 222. The processor 221 controls many functions of wearable heads-up display 220 and may be communicatively coupled to eye-tracker 225 to control functions and operations thereof. Memory 222 stores, at least, processor-executable input processing instructions 223 that, when executed by processor 221, cause eye-tracker 225 to cause input data to be sent to the second processor-based device 220 in response to detecting an eye position and/or gaze direction of the user. In the exemplary implementation depicted in FIG. 1, the instructions 223 may, upon execution by processor 221, cause wearable heads-up display 220 to transmit a signal to a server 330. In alternative implementations, the instructions 223 may, upon execution by processor 221, cause wearable heads-up display 220 to transmit a signal to a smartphone (not shown to reduce clutter), and then the smartphone may transmit the signal to the server 330. To this end, wearable heads-up display 220 also includes a wireless transceiver 224 to send/receive wireless signals to/from a server or smartphone. These same corresponding components may be found in the first processor-based device 120. The components of the server 330 are described in further detail below with respect to FIG. 6.

Referring now to FIG. 3, a system for reduced visual footprint of textual communications is shown with a first user 101 and a second user 201. The first user 101 has a first processor-based device 120 (e.g., a pair of smart glasses) as well as a smart phone 242 and a smart watch 244, each of which have small display screens that may display textual communications. The second user 201 has a second processor-based device 220 (e.g., another pair of smart glasses) as well as a fitness tracker device 246, each of which have small display screens that may display textual communications. Each of the processor-based devices of the first user 101 and the second user 201 have small display screens due to the overall small size of these electronic devices. As such, the use of the display screen's actual display area for communication purposes comes at a premium.

As shown in FIG. 3, in some implementations, the first processor-based device 120 of the first user 101 and the second processor-based device 220 of the second user 201 communicate via one or more intermediary processor-based device(s) (e.g., smartphone 242, server 330). In another aspect of some implementations, the first processor-based device 120 of the first user 101 and the second processor-based device 220 of the second user 201 communicate via cellular communication towers 340 and 342, as well as the intermediary processor-based device(s) (e.g., smartphone 242, server 330). In another aspect of some implementations, first processor-based device 120 of the first user 101 and second processor-based device 220 of the second user 201 communicate via other wired and/or wireless communication networks, either additionally or alternatively to the cellular communication towers 340 and 342 shown in FIG. 3. For example, other local area networks, wide area networks, satellite networks, cable networks, IEEE 802.11 networks, Bluetooth networks, and the like may be employed instead of other in combination with the cellular networks shown in FIG. 3 (e.g., Bluetooth communication between device 120 and smartphone 242, and cellular communication between smartphone 242 and tower 340).

Referring to FIGS. 1-3, in some implementations, the first user 101 creates the original textual message 132 on the first processor-based device 120 and sends, either directly or through any number of intervening devices/channels, the textual message 132 to the second user 201 to be displayed on the display screen 230 of the second processor-based device 220. In some implementations, the textual message 132 is SMS (Short Message Service)/MMS (Multimedia Messaging Service); however, the short textual message 132 may also be email, instant messaging, or any other messaging or communication service or protocol. Additionally, the textual message 132 may be created using any capable processor-based device, including smart glasses, as well as a smart phone 242, smart watch 244, fitness tracker devices 246, and the like.

In at least one implementation of the system for reduced visual footprint of textual communications 100, the system infrastructure receives the textual message 132, either directly or indirectly, from the first processor-based device 120 on the intermediary processor-based device 330 (e.g., server(s), cloud server(s), or the like). In some implementations, the textual message 132 is processed by a classifier 360 that analyzes the content of the textual message 132 and maps the content of the textual message 132 to the most appropriate single graphic or pictorial symbol 280. Otherwise stated, in some implementations, the processing by the classifier 360 and the mapping of the content of the textual message 132 summarizes the content of the textual message 132 with one graphic or pictorial symbol 280. A graphic or pictorial symbol 280 may be defined as a classifying and/or summarizing graphic or pictorial image that does not itself appear in the textual message 132. Notably, the graphic or pictorial symbols 280 are not characters in any known language. In various implementations, the classifier 360 may be stored in any non-transitory storage medium, and executed or otherwise employed by any processor communicatively coupled to such storage medium, of any processor-based device (e.g., smart glasses 120, smartphone 242, server 330, or smart glasses 220) that is part of the communication path from device 120 to device 220.

In at least one implementation of the system for reduced visual footprint of textual communications 100, the single graphic or pictorial symbol 280 may be an emoji or other pictorial symbol. Accordingly, in one such implementation, a textual message 132 of “hey do you want to meet up for coffee?” maps to a single symbol of a coffee cup. In other implementations, the single graphic or pictorial symbol 280 is a more sophisticated visual summary of the textual message 132. In some implementations, the graphic or pictorial symbol 280 is then either added to or substituted for the textual message data and sent to the second user 201 via the display screen 230 of the second processor-based device 220.

A list of graphic or pictorial symbols 280 in the system for reduced visual footprint of textual communications 100 includes, by way of example only, and not by way of limitation, icons, images, or pictorial representations of any one or more of: coffee, tea, food, breakfast, lunch, dinner, drinks, beer, cocktails, gym, running, workout, bicycling, movie, driving, boating, plane, beach, swim, ski, sleep, date, love, hate, shopping, dancing, sun, rain, snow, lightning, wind, wave, surf, fruit, vegetable, pizza, tacos, burgers, sushi, dessert, golf, tennis, hockey, basketball, football, soccer, bath, music, bowling, gambling, police, taxi, scooter, car, train, cruise, gas, Ferris wheel, volcano, rainbow, watch, phone, flashlight, credit card, money, hammer, wrench, knife, cigarette, bomb, chain, shower, groceries, keys, presents, mail, calendar, pen, pencil, lock, and clock.

In some implementations, the system for reduced visual footprint of textual communications 100 employs machine learning capabilities to develop the graphic or pictorial symbols 280. In this manner, the machine learning capabilities of the system 100 enable the classifier 360 to generate new and more accurate and/or efficient graphic or pictorial symbols 280 over time using the machine-learning-based classifier 360 which analyzes numerous incoming textual messages 132 for precise meaning. For example, the incoming textual messages 132 may incorporate slang or idioms that are not obvious in meaning when viewed from standard lexicon and syntax. In such instances, a system 100 that incorporates a machine-learning-based classifier 360 may learn the meaning of these slang or idioms and provide more accurate mapping to graphic or pictorial symbols 280.

Referring now to FIG. 4, in at least one implementation of a method for reduced visual footprint of textual communications 400, the method includes, at 410, identifying an original textual message 132 generated at a first processor-based device 120 that is designated for visual presentation via a second processor-based device 220, the original textual message 132 including a plurality of alphanumeric characters. At 420, the method 400 includes performing a classification on the original textual message 132 that converts the first textual message into one or more graphic or pictorial symbols 280. At 430, the method 400 includes causing a presentation of the one or more graphic or pictorial symbols 280 in lieu of, and without presentation of, the original textual message 132 by the second processor-based device 220.

As explained in greater detail with respect to FIGS. 1-3, in some implementations the textual message 132 and/or the graphic or pictorial symbol 280 are received by a smart phone of the second user 201 and then forwarded on to the smart glasses 220 of the second user 201. In one example, the smart glasses 220 of the second user 201 display a notification to the second user 201 which indicates that the second user 201 has received a message. The second user 201 may then elect to view the message, which is initially presented by the smart glasses 220 as only a graphic or pictorial symbol 280 designated from the first user 101. In another example, the smart glasses 220 of the second user 201 display the graphic or pictorial symbol 280 with the initial notification to the second user 201. This may be achieved, for example, by way of a pop-up notification that includes the graphic or pictorial symbol 280. In some instances, the second user 201 may fully understand the entirety of the textual message 132 from the graphic or pictorial symbol 280, and thus, viewing of the entire textual message 132 is not necessary. In other instances, the second user 201 may not fully understand the entirety of the textual message 132 from the graphic or pictorial symbol 280, resulting in the second user 201 selecting the graphic or pictorial symbol 280 (or selecting another activation point on the second processor-based device 220) in order to view the complete original textual message 132.

In other implementations of the system for reduced visual footprint of textual communications 100, the processing by the classifier 360, which analyzes the content of the original textual message 132 and maps the content of the textual message 132 at 420 of method 400, is performed at the first processor-based device 120 or the second processor-based device 220, instead of the intermediary processor-based device 330. In yet other implementations of the system for reduced visual footprint of textual communications 100, the classifier 360 is located and performs its functions in other intermediary component(s) positioned between the first processor-based device 120 and the second processor-based device 220.

In still other implementations of the system for reduced visual footprint of textual communications 100, the classifier 360 summarizes the content of the textual message 132 with two or more graphic or pictorial symbols 280 at 420 of method 400. In such an implementation, the two or more graphic or pictorial symbols 280 still occupy only a very small amount of surface area of a display screen 230, as compared to the original textual message 132. In one such implementation of the system for reduced visual footprint of textual communications 100, the classifier 360 summarizes the content of the textual message 132 with two graphic or pictorial symbols 280, where one graphic or pictorial symbol 280 refers to a noun, event, activity, or action summarizing the content of the message, and a second graphic or pictorial symbol 280 refers to a time, such as by utilizing a picture of a clock with the clock hands at a designated time period. Another potential graphic or pictorial symbol 280 may refer to a date, such as by utilizing a date of a calendar.

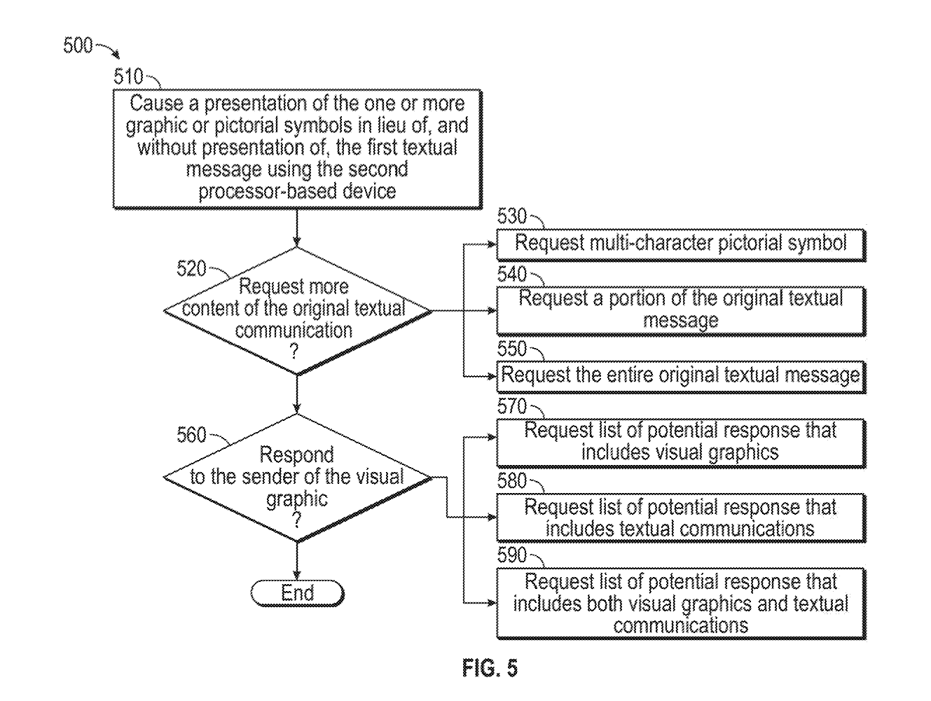

Referring now to FIG. 5, in another aspect of at least one implementation of a method for reduced visual footprint of textual communications 500, the method includes, at 510, causing a presentation of the one or more graphic or pictorial symbols in lieu of, and without presentation of, the first textual message using the second processor-based device. At 520, a recipient user requests more content of the original textual communication. The request options for more content may include: at 530, requesting multi-character graphical or pictorial symbols; at 540, requesting a portion of the original textual message; and/or at 550, requesting the entire original textual message. At 560, a recipient user receives options for responding to the sender of the first textual message, which was converted into the graphic or pictorial symbol. The options for responding to the sender may include: at 570, requesting a list of potential responses that includes visual graphics; at 580, requesting a list of potential responses that includes textual communications; and/or at 590, requesting a list of potential responses that includes both visual graphics and textual communications.

These options and functions are now explained in greater detail with respect to FIGS. 1-3. In some implementations of the system for reduced visual footprint of textual communications 100, when a textual message 132 passes through the system (e.g., on the intermediary processor-based device 330 “in the cloud”, which contains the classifier 360), the textual message 132 may also be analyzed to provide a list of potential responses to the presentation of the one or more graphic or pictorial symbols 280. In such an implementation, when the second user 201 views the message (either the graphic or pictorial symbol 280 or the full textual message 132), the second user 201 may be presented with a list of potential responses generated by the system 100, based on probability of each potential response being a suitable response. The potential responses may be presented as graphic or pictorial symbols 280 (e.g., emoji, other more sophisticated symbols, and the like), as brief textual responses, or combinations thereof.

Accordingly, in an instance where the first user 101 sends a textual message 132 to the second user 201 that is classified and converted into a graphic or pictorial symbol 280 representing a coffee cup, the second user 201 may be presented with a list of reply options including, by way of example only, and not by way of limitation, a graphic or pictorial symbol 280 representing: a “thumbs up,” a “thumbs down,” a clock symbol showing noon, a clock symbol showing three o'clock, and the like. Alternatively or additionally, the second user 201 may be presented with a list of reply options including, by way of example only, and not by way of limitation, a brief textual responses stating: “Sure.”, “What time?”, “Where?”, “Tomorrow instead?”, and the like. The second user 201 may then select their response and send the response back to the first user 101 either as a graphic/pictorial symbol 280, a brief textual response, or as a combination thereof. Other such brief textual responses may include, for example, questions like “What time?”, “What do we need from the store?”, or statements like “I'm on my way home,” “I'll be there in 15 minutes,” and the like.

In some implementations, the system for reduced visual footprint of textual communications 100 employs machine learning capabilities to develop the improved graphic or pictorial symbols 280 for responses and/or brief textual responses. In this manner, the machine learning capabilities of the system 100 enable the classifier 360 (or other component of the system) to generate new and more accurate and/or efficient response graphic/pictorial symbols 280, using the machine-learning-based classifier 360 which analyzes numerous incoming textual messages 132 over time for determining their precise meaning. As described above, the incoming textual messages 132 may incorporate slang or idioms that are not obvious in meaning when viewed from standard lexicon and syntax. In such instances, a system 100 that incorporates a machine-learning-based classifier 360 may learn the meaning of these slang or idioms and provide more accurate response graphic/pictorial symbols 280 or brief textual responses.

FIG. 6 shows a processor-based device suitable at a high level for implementing the first processor-based device 120, the second processor-based device 220, and/or the processor-based server 330, which are described above with respect to a system for reduced visual footprint of textual communications 100. Although not required, some portion of the implementations will be described in the general context of processor-executable instructions or logic, such as program application modules, objects, or macros being executed by one or more processors. Those skilled in the relevant art will appreciate that the described implementations, as well as other implementations, can be practiced with various processor-based system configurations, including handheld devices, such as smartphones and tablet computers, wearable devices such as smart glasses, multiprocessor systems, microprocessor-based or programmable consumer electronics, personal computers (“PCs”), network PCs, minicomputers, mainframe computers, and the like.

In the system for reduced visual footprint of textual communications 100, the processor-based device may, for example, take the form of a smartphone or wearable smart glasses, which includes one or more processors 606, a system memory 608 and a system bus 610 that couples various system components including the system memory 608 to the processor(s) 606. The processor-based device will at times be referred to in the singular herein, but this is not intended to limit the implementations to a single system, since in certain implementations, there will be more than one system or other networked computing device involved. Non-limiting examples of commercially available systems include, but are not limited to, ARM processors from a variety of manufactures, Core microprocessors from Intel Corporation, U.S.A., PowerPC microprocessor from IBM, Sparc microprocessors from Sun Microsystems, Inc., PA-RISC series microprocessors from Hewlett-Packard Company, and 68xxx series microprocessors from Motorola Corporation.

The processor(s) 606 in the processor-based devices of the system for reduced visual footprint of textual communications 100 may be any logic processing unit, such as one or more central processing units (CPUs), microprocessors, digital signal processors (DSPs), application-specific integrated circuits (ASICs), field programmable gate arrays (FPGAs), and the like. Unless described otherwise, the construction and operation of the various blocks shown in FIG. 6 are of conventional design. As a result, such blocks need not be described in further detail herein, as they will be understood by those skilled in the relevant art.

The system bus 610 in the processor-based devices of the system for reduced visual footprint of textual communications 100 can employ any known bus structures or architectures, including a memory bus with memory controller, a peripheral bus, and a local bus. The system memory 608 includes read-only memory (“ROM”) 612 and random access memory (“RAM”) 614. A basic input/output system (“BIOS”) 616, which can form part of the ROM 612, contains basic routines that help transfer information between elements within processor-based device, such as during start-up. Some implementations may employ separate buses for data, instructions and power.

The processor-based device of the system for reduced visual footprint of textual communications 100 may also include one or more solid state memories, for instance, a Flash memory or solid state drive (SSD), which provides nonvolatile storage of computer-readable instructions, data structures, program modules and other data for the processor-based device. Although not depicted, the processor-based device can employ other non-transitory computer- or processor-readable media, for example, a hard disk drive, an optical disk drive, or a memory card media drive.

Program modules in the processor-based devices of the system for reduced visual footprint of textual communications 100 can be stored in the system memory 608, such as an operating system 630, one or more application programs 632, other programs or modules 634 (including classifier 360 and associated processor-executable instructions), drivers 636 and program data 638.

The application programs 632 may, for example, include panning/scrolling 632a. Such panning/scrolling logic may include, but is not limited to logic that determines when and/or where a pointer (e.g., finger, stylus, cursor) enters a user interface element that includes a region having a central portion and at least one margin. Such panning/scrolling logic may include, but is not limited to logic that determines a direction and a rate at which at least one element of the user interface element should appear to move, and causes updating of a display to cause the at least one element to appear to move in the determined direction at the determined rate. The panning/scrolling logic 632a may, for example, be stored as one or more executable instructions. The panning/scrolling logic 632a may include processor and/or machine executable logic or instructions to generate user interface objects using data that characterizes movement of a pointer, for example, data from a touch-sensitive display or from a computer mouse or trackball, or other user interface device.

The system memory 608 in the processor-based devices of the system for reduced visual footprint of textual communications 100 may also include communications programs 640, for example, a server and/or a Web client or browser for permitting the processor-based device to access and exchange data with other systems such as user computing systems, Web sites on the Internet, corporate intranets, or other networks as described below. The communications program 640 in the depicted implementation is markup language based, such as Hypertext Markup Language (HTML), Extensible Markup Language (XML) or Wireless Markup Language (WML), and operates with markup languages that use syntactically delimited characters added to the data of a document to represent the structure of the document. A number of servers and/or Web clients or browsers are commercially available such as those from Mozilla Corporation of California and Microsoft of Washington.

While shown in FIG. 6 as being stored in the system memory 608, operating system 630, application programs 632, other programs/modules 634, drivers 636, program data 638 and server and/or browser can be stored on any other of a large variety of non-transitory processor-readable media (e.g., hard disk drive, optical disk drive, SSD and/or flash memory).

A user of a processor-based device in the system for reduced visual footprint of textual communications 100 can enter commands and information via a pointer, for example, through input devices such as a touch screen 648 via a finger 644a, stylus 644b, or via a computer mouse or trackball 644c which controls a cursor, or via an eye tracker 225. Other input devices can include a microphone, joystick, game pad, tablet, scanner, biometric scanning device, wearable input device, and the like. These and other input devices (i.e., “I/O devices”) are connected to the processor(s) 606 through an interface 646 such as a touch-screen controller and/or a universal serial bus (“USB”) interface that couples user input to the system bus 610, although other interfaces such as a parallel port, a game port or a wireless interface or a serial port may be used. The touch screen 648 can be coupled to the system bus 610 via a video interface 650, such as a video adapter to receive image data or image information for display via the touch screen 648. Although not shown, the processor-based device can include other output devices, such as speakers, vibrator, haptic actuator or haptic engine, and the like.

The processor-based devices of the system for reduced visual footprint of textual communications 100 operate in a networked environment using one or more of the logical connections to communicate with one or more remote computers, servers and/or devices via one or more communications channels, for example, one or more networks 614a, 614b. These logical connections may facilitate any known method of permitting computers to communicate, such as through one or more LANs and/or WANs, such as the Internet, and/or cellular communications networks. Such networking environments are well known in wired and wireless enterprise-wide computer networks, intranets, extranets, the Internet, and other types of communication networks including telecommunications networks, cellular networks, paging networks, and other mobile networks.

When used in a networking environment, the processor-based devices of the system for reduced visual footprint of textual communications 100 may include one or more network, wired or wireless communications interfaces 652a, 656 (e.g., network interface controllers, cellular radios, WI-FI radios, Bluetooth radios) for establishing communications over the network, for instance, the Internet 614a or cellular network 614b.

In a networked environment, program modules, application programs, or data, or portions thereof, can be stored in a server computing system (not shown). Those skilled in the relevant art will recognize that the network connections shown in FIG. 6 are only some examples of ways of establishing communications between computers, and other connections may be used, including wirelessly.

For convenience, the processor(s) 606, system memory 608, and network and communications interfaces 652a, 656 are illustrated as communicably coupled to each other via the system bus 610, thereby providing connectivity between the above-described components. In alternative implementations of the processor-based device, the above-described components may be communicably coupled in a different manner than illustrated in FIG. 6. For example, one or more of the above-described components may be directly coupled to other components, or may be coupled to each other, via intermediary components (not shown). In some implementations, system bus 610 is omitted and the components are coupled directly to each other using suitable connections.

Throughout this specification and the appended claims the term “communicative” as in “communicative pathway,” “communicative coupling,” and in variants such as “communicatively coupled,” is generally used to refer to any engineered arrangement for transferring and/or exchanging information. Exemplary communicative pathways include, but are not limited to, electrically conductive pathways (e.g., electrically conductive wires, electrically conductive traces), magnetic pathways (e.g., magnetic media), one or more communicative link(s) through one or more wireless communication protocol(s), and/or optical pathways (e.g., optical fiber), and exemplary communicative couplings include, but are not limited to, electrical couplings, magnetic couplings, wireless couplings, and/or optical couplings.

Throughout this specification and the appended claims, infinitive verb forms are often used. Examples include, without limitation: “to detect,” “to provide,” “to transmit,” “to communicate,” “to process,” “to route,” and the like.

Unless the specific context requires otherwise, such infinitive verb forms are used in an open, inclusive sense, that is as “to, at least, detect,” to, at least, provide,” “to, at least, transmit,” and so on.

The above description of illustrated implementations, including what is described in the Abstract, is not intended to be exhaustive or to limit the implementations to the precise forms disclosed. Although specific implementations of and examples are described herein for illustrative purposes, various equivalent modifications can be made without departing from the spirit and scope of the disclosure, as will be recognized by those skilled in the relevant art. The teachings provided herein of the various implementations can be applied to other portable and/or wearable electronic devices, not necessarily the exemplary wearable electronic devices generally described above.

For instance, the foregoing detailed description has set forth various implementations of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one implementation, the present subject matter may be implemented via Application Specific Integrated Circuits (ASICs). However, those skilled in the art will recognize that the implementations disclosed herein, in whole or in part, can be equivalently implemented in standard integrated circuits, as one or more computer programs executed by one or more computers (e.g., as one or more programs running on one or more computer systems), as one or more programs executed by on one or more controllers (e.g., microcontrollers) as one or more programs executed by one or more processors (e.g., microprocessors, central processing units, graphical processing units), as firmware, or as virtually any combination thereof, and that designing the circuitry and/or writing the code for the software and or firmware would be well within the skill of one of ordinary skill in the art in light of the teachings of this disclosure.

When logic is implemented as software and stored in memory, logic or information can be stored on any processor-readable medium for use by or in connection with any processor-related system or method. In the context of this disclosure, a memory is a processor-readable medium that is an electronic, magnetic, optical, or other physical device or means that contains or stores a computer and/or processor program. Logic and/or the information can be embodied in any processor-readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this specification, a “non-transitory processor-readable medium” can be any element that can store the program associated with logic and/or information for use by or in connection with the instruction execution system, apparatus, and/or device. The processor-readable medium can be, for example, but is not limited to, an electronic, magnetic, optical, electromagnetic, infrared, or semiconductor system, apparatus or device. More specific examples (a non-exhaustive list) of the computer readable medium would include the following: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), digital tape, and other non-transitory media.

The various implementations described above can be combined to provide further implementations. To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet, including U.S. Provisional Patent Application No. 62/577,081, US Patent Application Publication No. 2014-0198035 and US Patent Application Publication No. 2017-0097753, are incorporated herein by reference, in their entirety. Aspects of the implementations can be modified, if necessary, to employ systems, circuits and concepts of the various patents, applications and publications to provide yet further implementations.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A system for providing communication between processor-based devices, the system comprising:
at least one processor-readable medium communicatively coupled to at least one processor and which stores processor-executable instructions that, when executed by the at least one processor, cause the at least one processor to:
identify a first textual message generated at a first processor-based device that is designated for visual presentation via a second processor-based device, the first textual message including a plurality of alphanumeric characters,
perform a classification on the first textual message that converts the first textual message into one or more graphic or pictorial symbols; and
cause a presentation of the one or more graphic or pictorial symbols in lieu of, and without presentation of, the first textual message using the second processor-based device.

2. The system of claim 1, wherein the one or more graphic or pictorial symbols collectively occupy a smaller area than an area that would be occupied by the first textual message if presented in full at a same font and size as a presentation of the one or more graphic or pictorial symbols.

3. The system of claim 1, wherein the one or more graphic or pictorial symbols include no alphanumeric characters.

4. The system of claim 1, wherein the one or more graphic or pictorial symbols include at least one emoji character.

5. The system of claim 1, wherein the system performs the classification on the first textual message that converts the first textual message into one or more graphic or pictorial symbols using a machine-learning-based classifier.

6. The system of claim 1, wherein the system trains the classifier with the first textual message to generate more accurate graphic or pictorial symbols.

7. The system of claim 1, wherein the system transmits information to the second processor-based device that causes the presentation of the one or more graphic or pictorial symbols in lieu of, and without presentation of, the first textual message by the second processor-based device.

8. The system of claim 1, wherein the system transmits information that, at least initially, causes the presentation of the one or more graphic or pictorial symbols via at least the second processor-based device,
the at least initial presentation of the one or more graphic or pictorial symbols in lieu of, and without, the first textual message.

9. The system of claim 1, wherein the system receives the first textual message at an intermediary processor-based system directly or indirectly from the first processor-based device,
wherein the intermediary processor-based system performs the classification on the first textual message that converts the first textual message into one or more graphic or pictorial symbols.

10. The system of claim 9, wherein the system transmits information by the intermediary processor-based system directly or indirectly to the at least second processor-based device.

11. The system of claim 1, wherein the second processor-based device is a wearable heads-up display,
the system causing the presentation of the one or more graphic or pictorial symbols using the wearable heads-up display.

12. The system of claim 1, wherein the system receives user input that specifies the first textual message at the first processor-based device, and wherein the system performs the classification on the first textual message that results in one or more graphic or pictorial symbols using the first processor-based device.

13. The system of claim 1, wherein the system causes the presentation of the one or more graphic or pictorial symbols by transmitting information that includes (1) the one or more graphic or pictorial symbols, and (2) a first set of corresponding textual information that is presentable subsequently to the presentation of the one or more graphic or pictorial symbols, the first set of corresponding textual information not including the first textual message.

14. The system of claim 1, wherein the system transmits information that includes (1) the one or more graphic or pictorial symbols, and (2) the first textual message, which is presentable subsequently to the presentation of the one or more graphic or pictorial symbols.

15. The system any of claim 1, wherein the system transmits information that includes (1) the one or more graphic or pictorial symbols, (2) a first set of corresponding textual information, the first set of corresponding textual information not including the first textual message, and (3) the first textual message, presentable subsequently to the presentation of the one or more graphic or pictorial symbols.

16. The system of claim 1, wherein the system performs a classification on the first textual message that results in one or more possible responses to the first textual message, and wherein the system causes a presentation of the one or more possible responses via the at least second processor-based device.

17. The system of claim 16, wherein the one or more possible responses are represented in textual form.

18. The system of claim 16, wherein the one or more responses are represented in graphical or pictorial form.

19. The system of claim 16, wherein the system receives the first textual message at an intermediary processor-based system directly or indirectly from the first processor-based device, and wherein the intermediary processor-based system performs the classification on the first textual message that results in one or more possible responses.

20. The system of claim 16, wherein the one or more possible responses are presented, via the second processor-based device, as one or more graphical or pictorial symbols in lieu of, and without presentation of, textual representations of the one or more possible responses.

21. The system of claim 20, wherein the one or more possible responses are presented, via the second processor-based device, as one or more graphical or pictorial symbols in response to detection of an input at the second processor-based device.

22. The system of claim 21, wherein the one or more possible responses are presented, via the second processor-based device, as one or more textual representations of the one or more possible responses.

23. The system of claim 21, wherein the detected input at the second processor-based device comprises a user selection of one of the one or more graphical or pictorial symbol representations of the possible responses.

24. The system of claim 16, wherein the system trains a classifier using a selection of one of the possible responses as data for use in training the classifier.
